(19) United States
(12) Patent Application Publication
(10) Pub. No.: US 2011/0051046 A1
(43) Pub. Date: Mar. 3, 2011

(54) OPTICAL SHEET, BACKLIGHT UNIT AND LIQUID CRYSTAL DISPLAY DEVICE HAVING THE SAME AND METHOD OF FABRICATING OPTICAL SHEET

(76) Inventors: Sung-Hun KIM, Gyeonggi-Do (KR); Byoung-Ku Kim, Gyeonggi-Do (KR); Jae-Hyun Park, Busan (KR); Hyeok-Joon Yoon, Gyeongsangbuk-Do (KR)

(21) Appl. No.: 12/870,247

(22) Filed: Aug. 27, 2010

(30) Foreign Application Priority Data
Aug. 28, 2009 (KR) 10-2009-0080644

(51) Int. Cl. G02F 1/13357; F21V 5/02; B05D 5/06

(52) U.S. Cl. 349/65; 362/608; 362/326; 427/162

(57) ABSTRACT

Disclosed is to decrease a fabrication cost and reduce a thickness of a liquid crystal display device by processing light transmitted through a liquid guide plate by virtue of a single optical sheet, the optical sheet including a base film, a plurality of prism patterns extending from one side to another side of the base film, and refraction layers between the prism patterns, thereby totally reflecting light incident from the light guide plate to be supplied to a liquid crystal display panel.

Pursuant to 35 U.S.C. §119(a), this application claims the benefit of earlier filing date and right of priority to Korean Application No. 10-2009-0080644 filed on Aug. 28, 2009, the contents of which is incorporated by reference herein in its entirety.

### BACKGROUND OF THE INVENTION

1. Field of the Invention

The present invention relates to an optical sheet, backlight unit and a liquid crystal display device having the same.

2. Background of the Invention

Recently, the development of various types of portable electric equipment, such as mobile phones, personal digital assistants (PDAs), and note book computers, is increasing the demands on flat panel display devices which are applicable to those equipment and small in size, light in weight and power-efficient. Examples of the flat panel display device are a liquid crystal display (LCD) device, a plasma display panel (PDP) device, a field emission display (FED) device, a vacuum fluorescent display (VFD) device and the like. Studies on those devices are actively conducted. Among others, the LCD device is currently in the limelight in view of its mass production technology, facilitation of driving scheme and implementation of high color rendering property.

The LCD device is a transparent display device, which realizes a desired image on a screen by adjusting light transmitting a liquid crystal (LC) layer by virtue of refractive index anisotropy of liquid crystal molecules. Accordingly, the LCD device is provided with a backlight unit as a light source for generating light which transmits through the LC layer for realizing an image. In general, there may be two types of backlight units.

A first type of backlight unit is an edge type backlight unit which is installed at a side surface of a liquid crystal (LC) panel for emitting light toward the LC layer, and a second type of backlight unit is a direct type backlight unit which emits light directly below the LC panel.

The edge type backlight unit may be installed at the side surface of the LC panel to supply light to the LC layer via a reflector and a light guide plate, so as to be made thin in thickness, whereby it is usually used in a laptop computer or the like requiring a thin display device.

The direct type backlight unit may be configured such that light emitted from a lamp is supplied directly to the LC layer, so as to be applicable to a large LC panel. Also, this type backlight unit can provide high luminance, so, recently, it is usually used for fabrication of an LC panel for LCD TV.

FIG. 1 is a view briefly showing a structure of an LCD device having an edge type backlight unit.

As shown in FIG. 1, an LCD device 1 includes a liquid crystal (LC) panel 3, and a backlight unit 10 installed at a rear surface of the LC panel 3 for supplying light to the LC panel 3. The LC panel 3 is for actually displaying an image thereon, and includes first and second substrates 3a and 3b, such as glass, and a liquid crystal (LC) layer (not shown) interposing between the first and second substrates 3a and 3b. In particular, although not shown, the first substrate 3a is a thin film transistor (TFT) substrate for forming switching devices such as TFTs and pixel electrodes, and the second substrate 3b is a color filter substrate for forming a color filter layer thereon. Also, a driving circuit unit 5 is disposed at each side surface of the first substrate 3a so as to apply a signal to each of the TFTs and the pixel electrodes formed on the first substrate 3a.

The backlight unit 10 includes lamps 11 for actually emitting light, a light guide plate 13 for guiding light emitted from the lamps 11 toward the LCD panel 3, a reflector 17 for reflecting light emitted from the lamps 11 toward the light guide to plate 13 to improve light efficiency, and an optical sheet 20 disposed above the light guide plate 13 so as to diffuse and converge light guided by the light guide plate 13 for improvement of optical efficiency.

With the configuration of the backlight unit 10, light emitted from the lamps 11 installed at both side surfaces of the light guide plate 13 is incident onto the light guide plate 13 via the side surfaces of the light guide plate 13, and the incident light is then incident onto the LC panel 3 in a state where the optical efficiency of the light is improved by the optical sheet 20 disposed above the light guide plate 13.

The optical sheet 20 is provided with a diffusion sheet and a prism sheet, and configured such that light incident is diffused by the diffusion sheet and then turned toward a front surface by the prism sheet for output.

FIG. 2 is a perspective view showing in detail the optical sheet 16 having the diffusion sheet and the prism sheet.

As shown in FIG. 2, the LCD device 1 includes an LC panel 40 and a backlight unit 10. The backlight unit 10 is located below the LC panel 40 for supplying light to the LC panel 40.

The backlight unit 10 includes a light source 11 implemented as a lamp, a housing 12 for the light source 11, a light guide plate 13 disposed below the LC panel 40 to urge a side surface thereof contact the light source 11, a reflector 17 disposed below the light guide plate 13 for reflecting light incident onto a lower side of the light guide plate 13 toward the LC panel 40, a first diffusion sheet 22 disposed between the LC panel 40 and the light guide plate 13 for diffusing light guided by the light guide plate 13, a first prism sheet 26 disposed between the first diffusion sheet 22 and the LC panel 40 and having a plurality of prisms aligned in one direction so as to refract light diffused by the diffusion sheet 22 toward a front surface thereof, a second prism sheet 28 disposed on the first prism sheet 26 and having prisms aligned perpendicular to the prisms of the first prism sheet 26 so as to further refract the light refracted by the first prism sheet 26, and a second diffusion sheet 24 for further diffusing the light output from the second prism sheet 28 to supply uniform light to the LC panel 40.

The first diffusion sheet 22 and the second diffusion sheet 24 diffuse input light to obtain uniform light. The first prism sheet 26 and the second prism sheet 28 have the prisms, respectively, disposed perpendicular to each other, to make incident light refracted toward the front surface in x-axial and y-axial directions, thereby being input in a perpendicular direction to the surface of the LC panel 40.

However, for the backlight unit in the structure, the optical sheet 20 is implemented by using the first and second diffusion sheets 22 and 24, and the first and second prism sheets 26 and 28, thereby increasing a fabricating cost. Furthermore, the optical sheet 20 may cause the backlight unit to be thicker, which prevents an implementation of a thin LCD device.

### SUMMARY OF THE INVENTION

Therefore, to solve the problems of the related art, an object of the present invention is to provide a backlight unit capable of decreasing a fabricating cost and remarkably reducing a thickness of an LCD device by employing an optical sheet having prism patterns and refraction layers having a larger refractive index than that of the prism pattern, and an LCD device having the same.

To achieve these and other advantages and in accordance with the purpose of the present invention, as embodied and broadly described herein, there is provided a backlight unit including, a lamp for emitting light; a light guide plate for guiding light emitted from the lamp; an optical sheet for reflecting totally reflect light incident from the light guide plate, the optical sheet including a first base film, a plurality of prism patterns extending from one side of the first base film to another side thereof, and refraction layers each formed between the neighboring prism patterns; and a light blocking unit formed along at least one side of an upper surface of the optical sheet to block the light transmitted through the corresponding region, wherein a refractive index of the refraction layer is higher than that of the prism pattern such that the light transmitted through the refraction layer is totally reflected at an interface with the prism pattern.

A difference between the refraction index of the refraction layer and that of the prism pattern may be more than 0.1.

The refraction index of the refraction layer may be more than 1.51, and the refraction index of the prism pattern may be less than 1.50.

The light blocking unit may be formed of a black or gray ink or a white ink, or made of a light blocking tape.

In the present invention, light can be supplied almost perpendicular to a surface of the LC panel by virtue of a single optical sheet, resulting in remarkable decrease of the thickness of the LCD device and a fabrication cost thereof. Also, in the present invention, light can be supplied to the LC panel at an incident light angle of −10˜10° with respect to a normal of the LC panel (i.e., 80˜100° with respect to the surface of the LC panel), thus maximizing luminance, thereby implementing an image with high quality.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a structure of an LCD device according to the related art;

FIG. 2 is a disassembled perspective view showing the structure of the LCD device according to the related art;

FIG. 3 is a perspective view showing a structure of an LCD device in accordance with the present invention;

FIG. 4 is a sectional view showing the structure of the LCD device in accordance with the present invention;

FIGS. 5A and 5B are views showing a structure of an optical sheet of a backlight unit in accordance with the present invention;

FIG. 6 is an overview showing a path of light input to a light guide plate of the backlight unit;

FIG. 7 is a view showing a relation between an emitting light angle and luminance of light emitted from the light guide plate;

FIG. 8 is an overview showing the path change of light which is input to the light guide plate and transmitted therethrough by virtue of a prism sheet of the backlight unit;

FIG. 9 is a view showing a total reflection of light at the optical sheet according to the present invention;

FIG. 10 is a view showing a structure of an LC panel of the LCD device according to the present invention;

FIGS. 11A to 11D are views showing variations of the optical sheet according to the present invention; and

FIG. 12A is a view showing a light distribution of output light and a graph showing luminance with respect to an emitted light (ray) angle in the related art backlight unit, and FIG. 12B is a view showing a light distribution of output light and a graph showing luminance with respect to an emitted light angle according to the present invention.

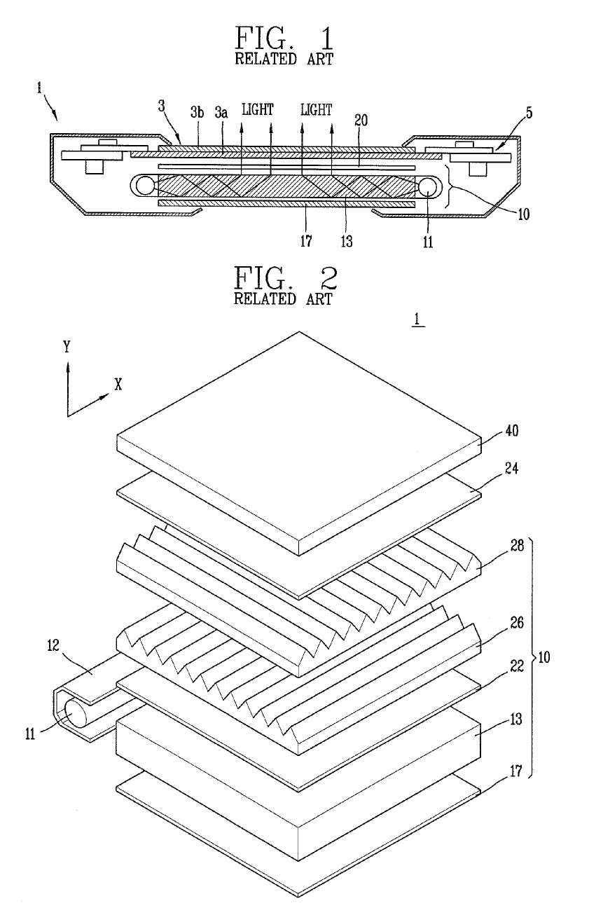

### DETAILED DESCRIPTION OF THE INVENTION

Hereinafter, a backlight unit for an LCD device in accordance with the present invention will be described with reference to the accompanying drawings.

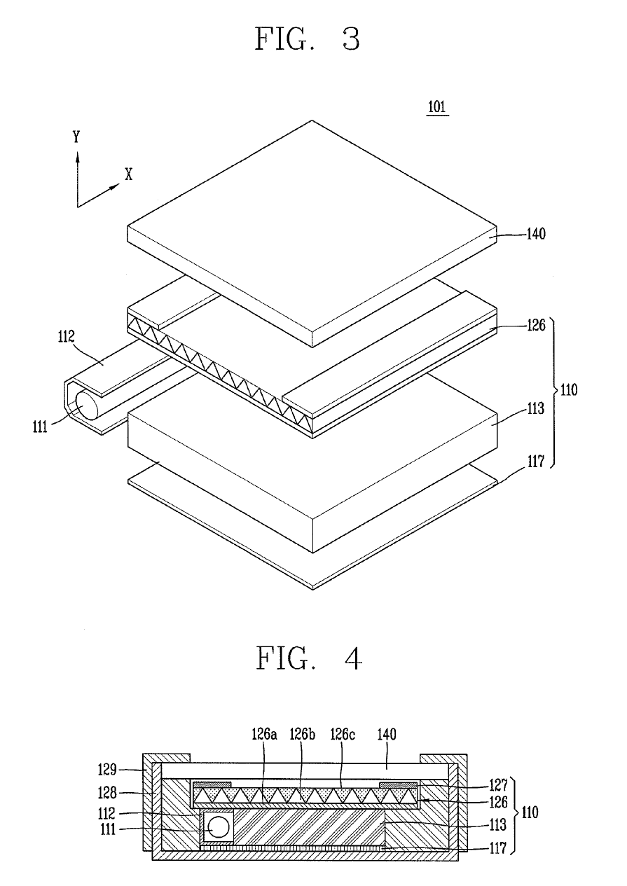

FIG. 3 is a view showing an LCD device 101 having a backlight unit 110 in accordance with the present invention.

As shown in FIG. 3, the LCD device 101 according to the present invention may include an LC panel 140 and a backlight unit 110. The backlight unit 110 may be present below the LC panel 140 so as to supply light to the LC panel 140.

The backlight unit 110 may include a light source 111 implemented as a lamp, a housing 112 for the light source 111, a light guide plate 113 disposed below the LC panel 140 to urge a side surface thereof contact the light source 111 so as to guide light input via the side surface thereof toward the LC panel 140, a reflector 117 disposed below the light guide plate 113 for reflecting light incident onto a lower side of the light guide plate 113 toward the LC panel 140, and an optical sheet 126 disposed above the light guide plate 113 and provided with a plurality of prism patterns aligned in one direction so as to converge light transmitted through the light guide plate 113.

FIG. 4 is a front view of the LCD device of FIG. 3. Hereinafter, the LCD device 101 according to the present invention will be described in more detail with reference to FIG. 4.

As shown in FIG. 4, the housing 112 is disposed at a side surface of the light guide plate 113, and disposes the light source 111 therein such that light is incident onto the light guide plate 113 via the side surface of the light guide plate 113. Although not shown, a reflective film may be coated on an inner surface of the housing 112. Accordingly, light emitted from the light source 111 (i.e., light emitted in directions other than from a side surface of the light guide plate 113) can be reflected toward the side surface of the light guide plate 113, thereby improving the efficiency of the light incident onto the light guide plate 113.

The reflector 117 may be located below the light guide plate 113. The reflector 117 is made of a material with high reflectance. If light guided via the light guide plate 113 is incident onto the lower surface of the light guide plate 113, the reflector 117 reflects the light so as to be supplied to the LC panel 140. The optical sheet 126 is disposed above the light guide plate 113 to converge and diffuse light output from the light guide plate 113 so as to be supplied to the LC panel 140.

The backlight unit 110 may be secured by a lower cover 128. The backlight unit 110 and the LC panel 140 may be assembled by the lower cover 128 and an upper cover 129.

The related art LCD device includes two diffusion sheets and two prism sheets to converge and simultaneously diffuse light output from a light guide plate, whereas the LCD device according to the present invention can implement light convergence and diffusion by virtue of a single optical sheet, whereby a fabricating cost can be reduced and the thickness of the backlight unit can be decreased.

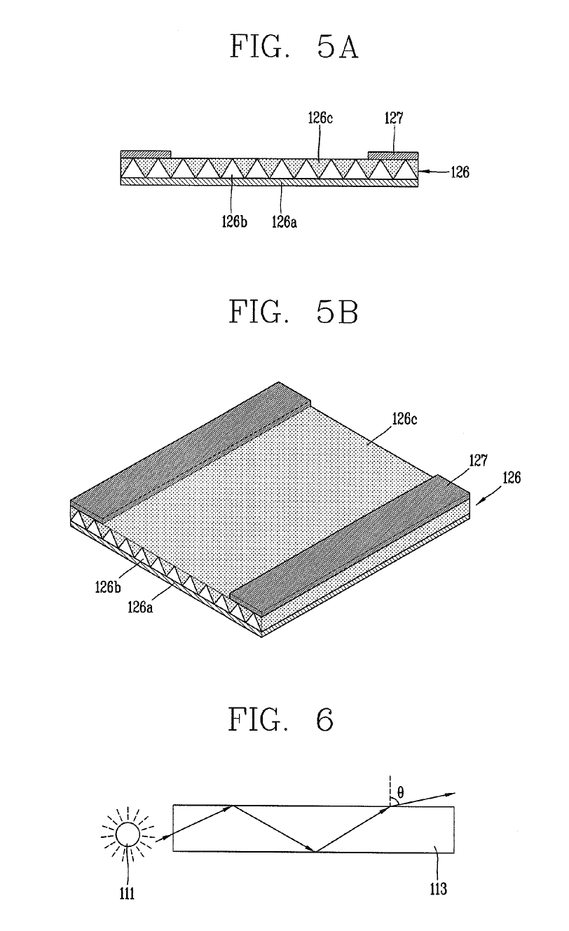

FIGS. 5A and 5B are views showing an optical sheet in accordance with the present invention.

As shown in FIGS. 5A and 5B, the optical sheet 126 may include a base film 126a, a plurality of prism patterns 126b extending from one side to another side of the base film 126a on the base film 126a, and refraction layers 126c filled in a space between two neighboring prism patterns 126b.

The base film 126a may be formed of polymethyl-methacrylate (PMMA), poly carbonate (PC) and the like, and the prism pattern 126b may be formed of UV-curable resin having a refractive index less than 1.5, PC and the like.

The prism pattern 126b is formed by depositing the UV-curable resin and the PC on the base film 126a and then patterning the deposited the UV-curable resin and the PC.

Here, the prism pattern 126b may have a section in a triangular shape like a mountain. A plurality of approximately equilateral triangles extending from one side of the base film 126a to another side thereof may be aligned on the entire surface of the base film 126a.

The refraction layer 126c may be formed of a material, such as UV-curable resin (e.g., having a refractive index more than 1.51), with a refractive index higher than that of the prism pattern 126b so as to be filled in each valley between the prism patterns 126b. An upper surface of each refraction layer 126c may be flat. The refractive index of each of the prism pattern 126b and the refraction layer 126c may depend on a size or thickness of the optical sheet 126, an angle or shape of the prism pattern 126b, and the like. However, in order to urge light transmitted through the refraction layer 126c totally reflected on the surface of the prism pattern 126b, a difference of the refractive index between the refraction layer 126c and the prism pattern 126c may preferably be more than 0.1.

Also, light blocking units 127 may be formed at both side surfaces of an upper surface of the refraction layer 126c. Each light blocking unit 127 is formed with a preset width along four edges of the refraction layer 126c so as to prevent degradation of image quality due to light leakage into the corresponding region.

In the present invention, the optical sheet 126 can be configured with the prism patterns 126b and the refraction layers 126c, so as to achieve the same effect as use of two prism sheets and two diffusion sheets, which will be described in more detail with reference to the drawing.

FIG. 6 is a conceptual view showing a path of light which is guided toward the light guide plate 113 and transmitted through the light guide plate 113 in the LCD device.

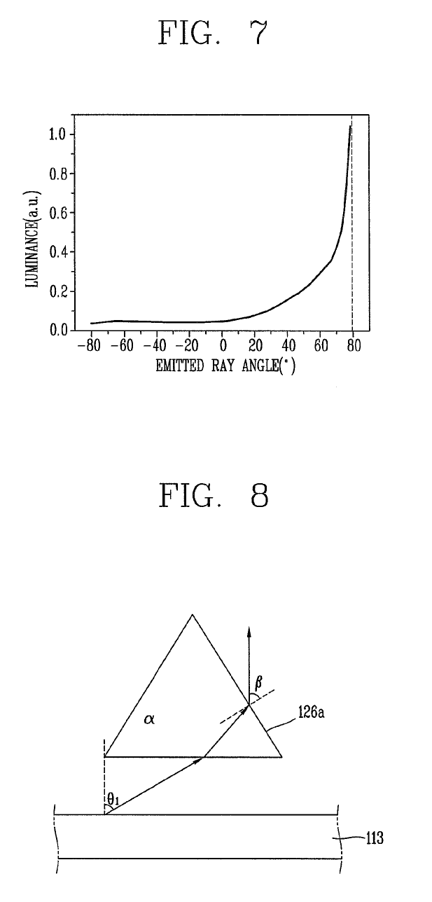

As shown in FIG. 6, after the light, which has been emitted from the light source 111 of the backlight unit for the LCD device, is incident onto the light guide plate 113, the incident light is totally reflected at upper and lower surfaces of the light guide plate 113. Afterwards, if the light is incident onto the upper surface by an angle larger than or equal to a threshold value, such light is output from the light guide plate 113 to be supplied to the LC panel 140. FIG. 7 shows luminance responsive to an emitted light (ray) angle θ in case of employing the wedge type light guide plate 113 as shown in the drawing.

Referring to FIG. 7, an emitted light angle θ of light transmitted through the light guide plate 113 is in the range of −80°≦θ≦80° based upon a normal of an upper surface of the light guide plate 113. However, luminance is weak at most of emitted light angles and is shown high at the emitted light angle approximately in the range of 40°≦θ≦80°. Especially, the luminance of emitted light is shown the highest at an angle θ over about 80°, which indicates that the light transmitted through the light guide plate 113 is usually output at an angle over 80°.

In the meantime, in the related art LCD device, light output from the light guide plate 113 is refracted by the prism sheets so as to be supplied perpendicular to the surface of the LC panel. However, in this case, as shown in FIG. 8, in order for light output from the light guide plate 13 to be refracted at the prism 26a of the prism sheet to be perpendicular to the surface of the LC panel, light should be emitted from the light guide plate 13 at an angle approximately in the range of 24° to 32° with respect to the prism 26a made of UV resin with a refractive index of about 1.58.

However, as mentioned above, since light output from the light guide plate 13 is mostly output at an emitted light angle larger than or equal to 80°, an angle of light, which is refracted by the prism 26a to be incident onto the LC panel, is not perpendicular, which may cause degradation of an image quality of the LCD device. Furthermore, if the emitted light angle 8 at the light guide plate 13 is more than 80°, light output from the light guide plate 13 is not actually incident onto the prism sheet but rather proceeds toward the side surface of the prism. That is, the output light is ongoing toward the side surface of the prism sheet without being incident onto the prism sheet. Consequently, the output light is incident onto the side surface of the backlight unit without being supplied to the LC panel.

The employment of the diffusion sheet between the light guide plate and the prism sheet in the related art backlight unit is for the purpose of diffusing light output from the light guide plate so as to change an incident angle of light incident into the prism sheet, thereby solving the aforesaid problem. Typically, if a diffusion sheet is placed at a light guide plate and a prism sheet to diffuse light transmitted through the light guide plate, the light luminance becomes high approximately in the range of 15°≦θ≦45°, especially, the luminance is the highest at an angle θ of about 40°.

Such angle overlaps with an angle approximately in the range of 24° to 32°, which is an angle of light from the light guide plate, for refracting, by the prism 26a of the prism sheet, the light transmitted through the light guide plate 13 to be perpendicular to the surface of the LC panel. Hence, this structure can improve the luminance of light incident onto the LC panel as compared with a structure without the diffusion sheet. However, the luminance is the highest at the angle θ of about 40° of light diffused by the diffusion sheet in the structure, whereas light is perpendicularly incident onto the LC panel at an emitted light angle of about 24° to 32°. Accordingly, the light with the highest luminance is still not supplied perpendicularly to the LC panel, thereby lowering optical efficiency.

In the present invention, the optical sheet 126 as shown in FIG. 5 is disposed above the light guide plate 113, so as to improve light convergence by virtue of a single prism sheet, reduce a fabricating cost and also minimize the thickness of the LCD device.

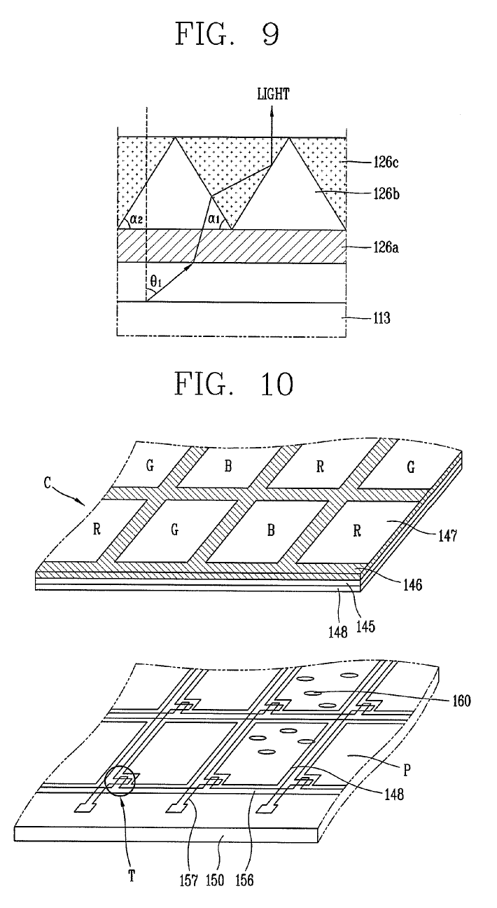

As shown in FIG. 9, light which is emitted from the lamp 111 and transmitted through the light guide plate 113 is output at an emitted light angle θ which is set with respect to a normal of the light guide plate 113, thereby being input into the optical sheet 126. Here, in the structure of the optical sheet 126, a vertex of the prism pattern 126b is aligned toward the LC panel 140, so light is refracted at a base plane of the prism pattern 126c to be incident onto the prism pattern 126b. The light incident onto the prism sheet 126b is refracted at a boundary (interface) surface between the prism pattern 126b and the refraction layer 126c to thereafter be transmitted through the refraction layer 126c, thereby being totally reflected at the surface of the prism pattern 126a.

Since the refractive index of the refraction layer 126c is higher than that of the prism pattern 126b, the light which is transmitted through the refraction layer 126c with the high refractive index and incident onto the prism pattern 126b is totally reflected at the boundary surface between the prism pattern 126b and the refraction layer 126c according to Snell's law.

In the related art backlight unit, the light transmitted through the light guide plate is input into the prism sheet and then refracted thereby so as to be supplied to the LC panel, whereas in the present invention, the light transmitted through the light guide plate is input into the optical sheet 126 and then totally reflected by the prism pattern 126b so as to be supplied into the LC panel 140.

In the present invention, if light is emitted at an angle θ of about 80° with respect to the normal of the light guide plate 113, the prism pattern 126b may have the base plane angles α1 and α2 smaller than or equal to 60°, preferably, in the range of 57° to 60°. As such, as the base plane angles α1 and α2 of the prism pattern 126b are set to 57° to 60°, light which is totally reflected by the prism can be perpendicularly incident onto the LC panel.

In order to maximize the luminance when light is incident onto the LC panel, it is the most preferable to set an incident angle with respect to the LC panel in the range of −10° to 10° with respect to the normal (i.e., 80° to 100° from the surface of the LC panel). Here, the ideal incident angle is 0°; however, since it is actually difficult to satisfy the angle and also is possible to realize an image with high quality although light is incident at an angle of −10˜10°, the incident angle of light with respect to the LC panel may preferably be set in the range of −10° to 10° with respect to the normal.

The present invention sets the base plane angles α1 and α2 of the triangular prism pattern 126b of the optical sheet 126 to 57° to 60°. Hence, the light emitted through the light guide plate 113 at an angle of about 80° can be totally reflected at the interface between the prism pattern 126b and the refraction layer 126c of the optical sheet 126 according to Snell's law, thereby being supplied to the LC panel at the angle of −10° to 10° with respect to the normal of the LC panel.

In the meantime, the prism pattern 126b of the optical sheet 126 is implemented in the shape of an equilateral triangle extending from one side of the base film 126a to another side thereof; however, the prism pattern 126b of the present invention may not be limited to this shape. Alternatively, if the prism pattern 126b can totally reflect light transmitted through the light guide plate 113 at the interface with the refraction layer 126c, the prism pattern 126b can be implemented in a shape of a lens or a polygonal shape, such as square or pentagon.

The light blocking units 127 may be formed along upper edges of the optical sheets 126. Each shielding unit 127 is configured to prevent deterioration of image equality, such as generation of spots on a screen, which is generated as light emitted to the side surface of the light guide plate 113 or from edge regions of the light guide plate 113 is transmitted through an outer region of the LC panel 140, namely, an image non-display region of the LC panel 140. The light blocking unit 127 may be formed along at least one line (edge) of an upper surface of the optical sheet 126 so as to block light from being transmitted through the corresponding region. The light blocking unit 127 may be formed by coating a black or gray ink or a white ink along at least one side, preferably, an entire outer sides of the upper surface of the optical sheet 126, or by attaching a light blocking tape onto the corresponding region.

A fluorescent lamp, such as cold cathode fluorescent lamp (CCFL), may usually be used as the light source 111 for emitting light to the light guide plate 113. Alternatively, the light source 111 may be implemented with a light emitting diode (LED) as well as the fluorescent lamp. The LED, as a light source which emits light by itself, emits R, G and B monochromatic light, so it can be advantageous in providing high color rendering characteristic and reducing driving power upon being applied to the backlight unit.

Upon employment of the LED as the light source 11 of the backlight unit, when light emitted from the LED is supplied to the LC panel, white light is supplied thereto other than monochromatic light being directly supplied thereto. For making white light by using the monochromatic light emitted from the LED, an LED emitting monochromatic light and phosphors may be used, an LED under infrared waveband and the phosphors may be used, or each monochromatic light emitted from R, G and B LEDs may be mixed. That is, upon use of the LED as the light source 111 of the backlight unit, a plurality of LEDs are located at a side surface of the light guide plate 113 so as to input white light or monochromatic light into the light guide plate 113.

The light guide plate 113 may be formed of polymethyl-methacrylate (PMMA). When light incident on one side surface or both side surfaces of the light guide plate 113 is then incident on an upper or lower surface inside the light guide plate 113 at an angle smaller than a threshold angle, such light is totally reflected to proceed from one side of the light guide plate 113 to another side thereof. On the other hand, when light is incident on the upper or lower surface inside the light guide plate 113 at an angle larger than a threshold angle, such light is output externally to be reflected by the reflector 117 or incident onto the optical sheet 126.

The drawing shows the light guide plate 113 which is generally in a planar shape with a uniform thickness; however, without limitation to this, a wedge type light guide plate may alternatively be used, which has a width gradually reduced as being farther away from a region facing the light source 111, namely, in the light proceeding direction. Formless spot patterns may be formed on the upper or lower surface of the light guide plate 113.

The pattern may diffuse light incident on the upper or lower surface of the light guide plate 113 so as to allow uniform light to be transmitted through the light guide plate 113. Also, the formless spot pattern may be formed on both the upper and lower surfaces of the light guide plate 113.

In addition, prisms may be formed on the upper or lower surface of the light guide plate 113. The prism may have a section in a triangular, lens-like or polygonal shape so as to extend from one side to another side on the upper or lower surface of the light guide plate 113. Thus, as the prism is formed on the light guide plate 113, the light convergence can be improved, as compared with the formation of the formless spot pattern, which allows further enhancement of optical efficiency supplied to the LC panel 140.

When the prism is formed on the upper or lower surface of the light guide plate 113, a formless spot pattern may be formed on the other surface, namely, the lower or upper surface of the light guide plate 113. Also, the prism may be formed on both the upper and lower surfaces of the light guide plate 113.

Meanwhile, the reflector 117 may be provided at the lower surface of the light guide plate 113. Thus, if the prism is formed on the lower surface of the light guide plate 113, the prism comes in contact with the lower light guide plate 117 so as to be damaged, accordingly, the prism may preferably be formed on the upper surface of the light guide plate 113.

Also, if the prism is formed on the upper or lower surface of the light guide plate 113, the prism may preferably extend perpendicular to a direction that the prism pattern 126b of the optical sheet 126 extends. As such, as the prism of the light guide plate 113 and the prism of the optical sheet 126 are formed perpendicular to each other, light which is transmitted through the light guide plate 113 and totally reflected by the optical sheet 126 can be supplied to the LC panel in a perpendicular direction to the surface of the LC panel 140.

Referring to FIG. 10, the LC panel 140 may include a first substrate 150, a second substrate 145 and an LC layer (not shown) interposing therebetween. If a plurality of gate lines 156 and data lines 157 are aligned on the first substrate 150 in a matrix configuration so as to define a plurality of pixel regions P, each pixel region P is provided with a thin film transistor (TFT) T and a pixel electrode 158 electrically connected to the TFT T. A gate pad and a data pad are formed at end portions of the gate line 156 and the data line 157, respectively, so as to connect the gate line 156 and the data line 157 to external driving devices, thereby allowing an input of an external signal via the gate line 156 and the data line 157.

Although not shown, the TFT T may include a gate electrode connected to the gate line 156 for allowing an input of an external scan signal via the gate line 156, a gate insulating layer formed on the gate electrode, a semiconductor layer formed on the gate insulating layer and activated responsive to an input of a scan signal to the gate electrode so as to form a channel, and source and drain electrodes formed on the semiconductor layer for applying an image signal input via the data line 157 to the pixel electrode 158 as the channel is formed on the semiconductor layer responsive to the scan signal.

The second substrate 145 may include a black matrix 146 formed on an image non-display region, on which an image is not actually realized, such as the formation regions for the gate lines 156, data lines 157 or the TFTs, so as to prevent degradation of image quality due to light transmission through the image non-display region, and a color filter layer 147 formed within a pixel region and having red (R), green (G) and blue (B) sub color filter layers for rendering an actual image.

An LC layer (not shown in a drawing) is present between the first and second substrates 150 and 145 having the aforesaid structure, thereby implementing the LC panel 140.

As described above, the present invention can employ the single optical sheet 126 instead of two prism sheets and two diffusion sheets used in the related art, resulting in remarkable reduction of the thickness of the LCD device and a fabrication cost thereof.

Here, in the structure of the optical sheet 126, the prism patterns 126b are formed on the base film 126a and the refraction layers 126c are formed by filling a material, which has a higher refractive index than that of the prism pattern 126b, between the prism patterns 126b. Accordingly, light refracted at the refraction layers 126c is allowed to be totally reflected at the interfaces with the prism patterns 126b, thereby improving optical efficiency.

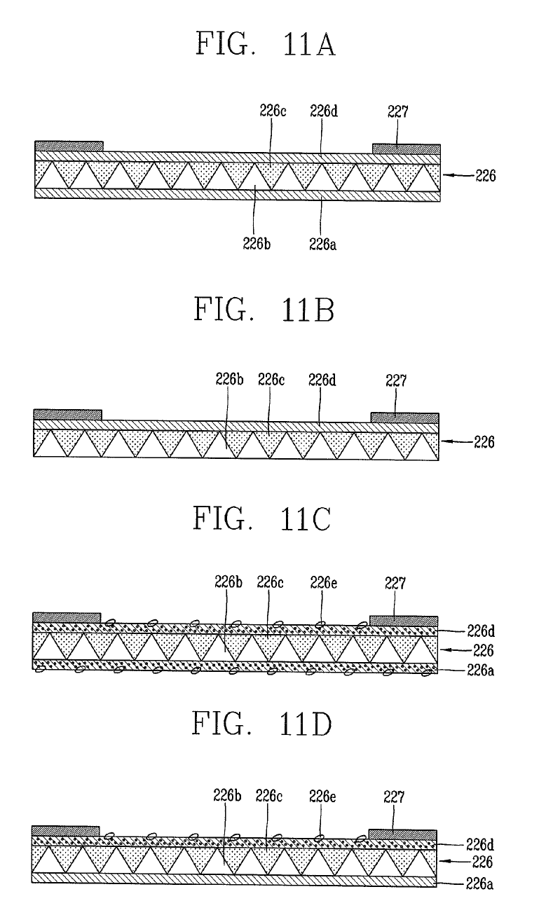

However, the optical sheet may not be limited to this structure, but applicable to various structures. FIGS. 11A to 11D are views showing optical sheets in various structures.

As shown in FIG. 11A, an optical sheet 226 may include a first base film 226a, prism patterns 226b formed on the first base film 226a, refraction layers 226c each formed at a space between the neighboring prism patterns 226b, a second base film 226d formed on the prism patterns 226b and the refraction layers 226c, and light blocking units 227 formed on one surface of the second base film 226d along at least one side of the second base film 226d.

The first base film 226a and the second base film 226d are formed of a material, such as polymethyl-methacrylate (PMMA), poly carbonate (PC) or the like. The prism pattern 226b is formed of a material, such as UV-curable resin, PC or the like, and the refraction layer 226c is formed of UV-curable resin. Here, the refractive index of the refraction layer 226c is higher than that of the prism pattern 226b and the difference of the two refractive indexes is more than 0.1, accordingly, light which is transmitted through the refraction layer 226c and then incident onto the prism pattern 226b may preferably be totally reflected at the interface (boundary) between the refraction layer 226c and the prism pattern 226b.

The optical sheet 226 shown in FIG. 11B has a structure excluding the first base film 226a from the optical sheet 226 with the structure of FIG. 11A. That is, the refraction layers 226c are formed on the second base film 226d, and the prism patterns 226b are formed by filling a material, which has a higher refractive index than that of the refraction layer 226c, between the refraction layers 226c.

In the optical sheet 226 with a structure shown in FIG. 11C, the prism patterns 226b and the refraction layers 226c are disposed between the first base film 226a and the second base film 226d, and beads 226e are distributed at the first and second base films 226a and 226d, respectively. The beads 226e may diffuse light incident on and transmitted through the optical sheet 226 such that uniform light can be supplied to the LC panel.

Also, the first base film 226a and the second base film 226d may contain therein or be externally coated with a diffusion material, such as PMMA, poly-n-butylmethacrylate (PBMA), silica, PC or the like, thereby enabling light diffusion.

The optical sheet 226 with a structure shown in FIG. 11D the beads 226c (or a diffusion material) are not distributed at the first base film 226a but distributed at the second base film 226a. Alternatively, the optical sheet 226 may have structure in which the beads 226e are distributed not at the second base film 226d but at the first base film 226a.

As described above, in the present invention, one optical sheet is employed to totally reflect light transmitted through the light guide plate, accordingly, light output from the light guide plate can be supplied to the LC panel in a perpendicular direction to the surface of the LC panel.

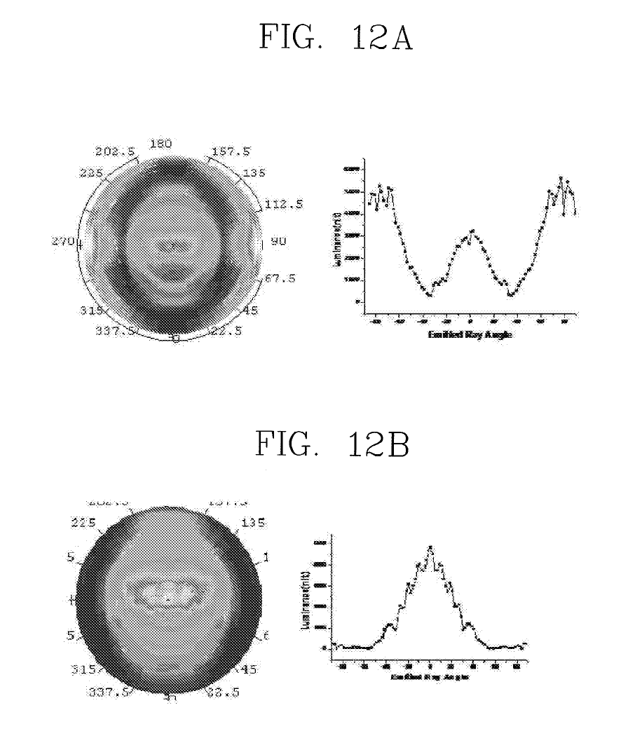

FIG. 12A shows a light distribution of light output from the prism sheet of the related art backlight unit and a graph which shows luminance with respect to an emitted light angle, and FIG. 12B shows a light distribution of light output from the prism sheet of the backlight unit according to the present invention and a graph which shows luminance with respect to an emitted light angle.

As shown in FIG. 12A, in the related art backlight unit using two prism sheets and two diffusion sheets, light shows the highest luminance at angles of about −80° and 80° with respect to the normal of the LC panel surface, and the second highest at an angle of 0°. That is, most light refracted by the prism sheets proceeds in a direction with the angles of −80° and 80°, and the rest proceeds in a direction with the angle 0°. However, the direction with the angles of about −80° and 80° with respect to the normal of the LC panel surface is a side direction of the LC panel other than toward the front surface of the LC panel. Therefore, in the related art backlight unit, most light proceeds towards the side surface of the backlight unit other than being supplied to the LC panel, thereby lowering optical efficiency.

On the other hand, as shown in FIG. 12B, in the present invention, the luminance is the highest near the angle of 0° and nearly 0 at other regions. This indicates that light totally reflected by the optical sheet is supplied at an angle of 0° from the normal of the surface of the LC panel, resulting in remarkable improvement of optical efficiency as compared with the related art.

As described above, the present invention removes a diffusion sheet and employs an optical sheet including prism patterns and refraction layers on the light guide plate to render light transmitted through the light guide plate totally reflected by the optical sheet, thereby supplying light to the LC panel perpendicular to the surface thereof.

In the meantime, the specific structures of the LC panel and the backlight unit described above are merely illustrative, but not intended to limit the present invention. For example, the base plane angles of the prism pattern of the optical sheet may be the same or different at both sides. Also, height or width of the prism pattern may be set differently if necessary, and the prism pattern may be designed in various shapes. In other words, other embodiments or variations of the LCD device using the basic concept of the present invention may easily be derived by a person skilled in the art.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A backlight unit comprising:
a lamp for emitting light;
a light guide plate for guiding light emitted from the lamp;
an optical sheet for reflecting totally reflect light incident from the light guide plate, the optical sheet including a first base film, a plurality of prism patterns extending from one side of the first base film to another side thereof, and refraction layers each formed between the neighboring prism patterns; and
a light blocking unit formed along at least one side of an upper surface of the optical sheet to block the light transmitted through the corresponding region,
wherein a refractive index of the refraction layer is higher than that of the prism pattern such that the light transmitted through the refraction layer is totally reflected at an interface with the prism pattern.

2. The backlight unit of claim 1, wherein a difference between the refraction index of the refraction layer and that of the prism pattern is more than 0.1.

3. The backlight unit of claim 2, wherein the refraction index of the refraction layer is more than 1.51, and the refraction index of the prism pattern is less than 1.50.

4. The backlight unit of claim 1, wherein the light blocking unit is formed of one of a black ink, gray ink, and a white ink.

5. The backlight unit of claim 1, wherein the light blocking unit is made of a light blocking tape.

6. The backlight unit of claim 1, further comprising a diffusion material for diffusing input light which is dispersed into the first base film.

7. The backlight unit of claim 1, further comprising a second base film formed on the prism patterns and the light blocking unit.

8. The backlight unit of claim 7, wherein the second base film contains a diffusion material.

9. The backlight unit of claim 1, further comprising formless spot patterns formed on at least one of upper and lower surfaces of the light guide plate.

10. The backlight unit of claim 1, further comprising prisms formed on at least one of upper and lower surfaces of the light guide plate.

11. The backlight unit of claim 1, further comprising:
prisms formed on at least one of an upper surface or a lower surface of the light guide plate; and
formless spot patterns formed on another surface of the light guide plate.

12. A liquid crystal display device comprising:
a liquid crystal display panel displaying an image thereon;
a lamp for emitting light;
a light guide plate for guiding the light emitted from the lamp;
an optical sheet for reflecting totally reflect light incident from the light guide plate to the liquid crystal display panel, the optical sheet including a first base film, a plurality of prism patterns extending from one side of the first base film to another side thereof, and refraction layers each formed between the neighboring prism patterns; and
a light blocking unit formed on an upper surface of the optical sheet along an edge region of the liquid crystal display panel to block light transmitted through the corresponding region,
wherein a refractive index of the refraction layer is higher than that of the prism pattern such that the light transmitted through the refraction layer is totally reflected at an interface with the prism pattern.

13. An optical sheet suitable to a backlight of a display device, comprising:
a first base;
a plurality of prism patterns on the first base film, the prism patterns being extended from one side end to the other side end of the base film;
refraction layers between the prism patterns to reflect totally the incident light, a refractive index of the refraction layer being higher than that of the prism pattern to reflect totally the light transmitting through the refraction layer at the boundaries of the prism patterns and the refraction layers; and
a light blocking unit along at least one side of an upper surface of the optical sheet to block the light transmitted through the corresponding region

14. The optical sheet of claim 13, wherein a difference between the refraction index of the refraction layer and that of the prism pattern is more than 0.1.

15. The optical sheet of claim 13, wherein the refraction index of the refraction layer is more than 1.51, and the refraction index of the prism pattern is less than 1.50.

16. The optical sheet of claim 13, further comprising a diffusion material for diffusing input light which is dispersed into the first base film.

17. The optical sheet of claim 13, further comprising a second base film formed on the prism patterns and the light blocking unit.

18. The optical sheet of claim 17, wherein the second base film contains a diffusion material.

19. A method of fabricating an optical sheet, comprising:
providing a first base;
forming a plurality of prism patterns on the first base film, the prism patterns being extended from one side end to the other side end of the base film;
forming refraction layers between the prism patterns to reflect totally the incident light, a refractive index of the refraction layer being higher than that of the prism pattern to reflect totally the light transmitting through the refraction layer at the boundaries of the prism patterns and the refraction layers; and
introducing a light blocking unit along at least one side of an upper surface of the optical sheet to block the light transmitted through the corresponding region

20. The method of claim 19, further comprising dispersing a diffusion material to the first base film to diffuse the incident light.

21. The method of claim 19, further comprising forming a second base film on the prism patterns and the light blocking unit.

22. The backlight unit of claim 21, wherein the second base film contains a diffusion material.
